(19) United States
(12) Patent Application Publication
(10) Pub. No.: US 2008/0065657 A1
(43) Pub. Date: Mar. 13, 2008

(54) RESOURCE MANAGEMENT SYSTEM USING PRE-ESTABLISHED HIERARCHICAL STRUCTURE

(76) Inventors: Diethard Kumpf, Kassel (DE); Christoph Stuhldreier, Burghasungen (DE)

Correspondence Address: SYNNESTVEDT & LECHNER, LLP, 1101 MARKET STREET, 26TH FLOOR, PHILADELPHIA, PA, 19107-2950, US

(21) Appl. No.: 11/852,768

(22) Filed: Sep. 10, 2007

Related U.S. Application Data
(60) Provisional application No. 60/824,997, filed on Sep. 8, 2006.

(51) Int. Cl. G06F 17/30

(52) U.S. Cl. 707/100; 707/E17.045

(57) ABSTRACT

Each component type to be utilized within a system is given a generic component type identifier. Thus, for example, it may be determined that in a particular system, there are eight component types, comprising a rack, a panel, a unit, a pin, a main distribution unit (MDU), a node, a port, and a modem. As an initial step, each of these component types is identified and given a unique component identification number or other unique designation. Then, specific instances of components are identified so that a hierarchical order can be established to establish a relationship between each specific instance of a component.

### CROSS-REFERENCE TO RELATED APPLICATIONS

This application is based on and claims priority to U.S. Provisional Application No. 60/824,997, filed Sep. 8, 2006, the contents of which are fully incorporated herein by reference.

### BACKGROUND OF THE INVENTION

### Field of the Invention

There are numerous products and/or services offered by companies that involve the delivery of services via combinations of components. Examples of such companies include public utilities, power companies, facilities management companies, and telecommunications companies. These companies typically offer “packages” of services to their customers that are essentially selected from a menu of services available. For example, a telecommunications company might offer a cable television package, a DSL (digital subscriber line) communications package, a voice telephone package, a long-distance package, a local telephone package, etc. In addition, these companies typically provide combination packages whereby a customer may order a combined voice and DSL package; cable and voice package; etc.

Providing these services in an organized manner is a daunting task. A telecommunication company must manage the allocation and operation of literally millions of components in an organized manner, so that the desired service(s) can be provided as requested, and so that the customers can be properly and accurately billed for receiving such service(s). To accomplish this task, conventional resource management systems map the hardware structures used to provide the services in what is known as a “fixed data structure”. In a fixed data structure, typically a hierarchical network structure is established. In a typical three-level hierarchical network each level of the hierarchy requires a stand-alone table, identifying the various components and their interconnections. A disadvantage exists when trying to make changes in such a network. If a level is to be added, the new level requires a new table within the data model, and the software making use of the structure must be adapted to reflect the changes. Further, some systems are only capable of mapping hardware structures of a single hardware vendor. Although helping with organization of the service delivery, such structures are difficult to manage, and this can slow down the service provider's ability to satisfy customer needs and provide services in a timely manner.

Quick time to market response is essential for Telco companies. To satisfy customer needs products and services have to be available and delivered in a timely manner. Therefore, to sell their products a Telco has to manage technical resources and network components. A transparent and efficient resource management system and method is needed to accomplish this goal.

In addition, a solution to this problem should be flexible, allowing the ability to build new components and deploy them without having to change the entire data model, and provide a way to show the relationships between network elements and the services being provided to the end-customer.

Conventional resource management systems map the hardware structures of a Telco network in a fixed data structure. For example, FIG. 1 illustrates a conventional 3 Level fixed data structure hierarchical network. When it comes to implementing changes to such a structure there are disadvantages. As shown, each level has its own table (Table 1 is for the first level, Table 2 is for the second level, and Table 3 is for the third level) and each table is populated with data corresponding to the components needed in that level. Adding a level (e.g., Table X as shown) requires adding a new table within this data model and an adaptation of the software that is making use of the data structure. Further, some systems can only map hardware structures pertaining to one particular hardware vendor; thus, if it is desired to use components of another vendor, these systems may not be able to accommodate this desire.

When there are different tree structures that a Telco or other entity wishes to support, typically these different tree structures are created in parallel. This increases the complexity of maintenance, and is quite restrictive when responding to market changes.

### SUMMARY OF THE INVENTION

The present invention enables a service provider or carrier, such as a telecommunications company, to respond quickly to market changes, map the hardware of any manufacturer and manage flexibly changes of internal network structures. The present invention provides a unique database model and method for structuring a resource management system enabling flexibility and ease of management.

In accordance with the present invention, each component type to be utilized within a system is given a generic component type identifier. As an initial step, each of these component types is identified and given a unique component identification number or other unique designation. Next, specific instances of components are identified so that a hierarchical order can be established to establish a relationship between each specific instance of a component.

### BRIEF DESCRIPTION OF THE DRAWINGS

FIG. 1 illustrates a conventional 3 level fixed data structure hierarchical network;

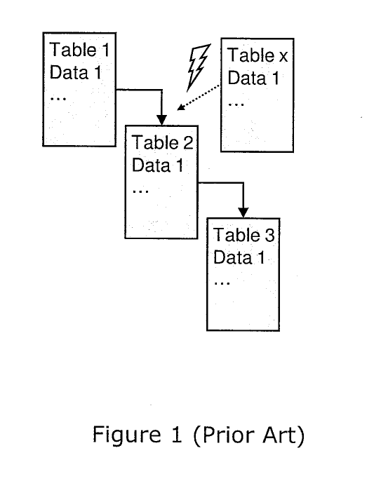

FIG. 2 shows an MDU (Main Distribution Unit) structure illustrative of those used in the Telco industry, with a data structure in accordance with the present invention;

FIG. 3 illustrates an example of a table referred to herein as a SERVICE_DATA table;

FIG. 4 shows an example of the structure of the SERVICE_COMPONENTS table and its relationship to the SERVICE_DATA table;

FIG. 5 illustrates the configuration of a resource;

FIG. 6 illustrates a resource package which is stored in a RESOURCE_PACKAGES table;

FIG. 7 shows a typical set of components that might be found in a Telco structure;

FIG. 8 is a screenshot which displays the defined component types of an existing system. Highlighted is a port of an EKSOS node (for voice service) with the property titles;

FIG. 9 illustrates an example of an element structure;

FIG. 10 is a screenshot which shows the elements in a hierarchical order;

FIG. 11 shows the number of nodes needed to display a network object is freely definable;

FIG. 12 shows an example of a defined resource;

FIG. 13 is a screenshot which displays the content of the highlighted resource of type ‘DSL2+ V5.2 Analog+ISDN’;

FIG. 14 illustrates a representative workstation hardware environment in which the present invention may be practiced; and

FIG. 15 illustrates a data processing network 1540 in which the present invention may be practiced

### DETAILED DESCRIPTION OF THE INVENTION

In accordance with the present invention, each component type to be utilized within a system is given a generic component type identifier. Thus, for example, it may be determined that in a particular system, there are eight component types, comprising a rack, a panel, a unit, a pin, a main distribution unit (MDU), a node, a port, and a modem. As an initial step, each of these component types is identified and given a unique component identification number or other unique designation. It is noted that the component types listed above are given for purposes of example only and it is understood that any component type being used in a system will be identified during this initial identification step.

Next, specific instances of components are identified so that a hierarchical order can be established to establish a relationship between each specific instance of a component. Each specific instance of a component within a system is referred to as an element (which also may be referred to as an “object”). An element is a specific component within the hierarchical order (described below). For example, a main distribution unit, or MDU, is both a component type in its generic sense, as well as an element in its specific sense. There may be a specific instance of four MDUs, two of which are identical and the other two which are different types of MDUs. Each of these is the same component type, that is each is an MDU and is identified as an MDU component type by the same component type identifier that is given to all MDUs. However, each of them is also an element, and each is a unique element, in that each specific instance of the MDU has a unique element number identifying the specific instance of that MDU and distinguishing it from all other instances of MDUs, be they the same type of MDU or a different type of MDU.

The defining of elements requires knowledge of the various components used in the system. For example, it may be that to provide DSL service, a branch is required comprising an MDU having a rack connected to two panels, with the two panel providing access to a certain number of pins, all of which will provide a particular connection between a customer and a particular type of service via the main distribution unit. A second branch may also be required to provide a direct connection from the MDU to a modem, and a third branch may be required connecting the same MDU to a node, which connects to a unit, which connects to a port. All of the specific instances of the components described above will be identified as elements in the system, and each time a customer requires DSL service, a new set of elements made up of the specific instances of these components will be defined.

Once the identity of each specific instance of a component (the elements) for the system is known, then relationships between the various components are determined and put into a hierarchical order. The hierarchical order is merely the interconnection of the elements needed for a particular service, and this interconnection is called a resource (e.g., one grouping of the above components required for providing DSL service defines a resource that is used to provide DSL service). This grouping or resource will be used each time the same service is required by another (or the same) customer. Resource types are sets of various components which are needed to provide a service by a service provider. For example, a resource type could be a “DSL Resource” and may require several components to make the service available. To provide DSL service to a subscriber, each element needed for the service must be linked to the resource “DSL Resource”. This resource will be directly linked to a subscriber.

If a customer is ordering a package comprising DSL service and voice service, the customer will have to have an access point to which his or her subscriber terminal is connected, and the service will be delivered to this access point. The access point is connected to the elements needed to provide the DSL and voice services, and the combination of these elements and the manner in which they are interconnected is called a resource. A resource consists of all elements (active or passive components) from the access point to the source of the services, and the relationship between all of these components. This created resource is assigned to a service which is integrated in the customer's contract. Since it is known what components are needed to provide these services, it is possible to show, on a contract level, the network elements that are in use, or will be used by, a particular customer.

By establishing a parent child relationship between each element in a resource, management of the resources becomes a simpler process than has been known in the past. If a new resource is desired, the telecommunications company knows how many and which elements are required to provide that service, and how to connect the elements to provide that service. Space allocation can then be made, e.g., in panels, racks, etc. to provide the service for the number of customers requesting the service, in a simple and straightforward manner. It is easy to add or subtract space as needed, since the hierarchical structure involving parent-child relationships has been pre-established. It provides the ability to treat the elements almost as “modules” that can be plugged in or removed as needed.

Following is a detailed description of an embodiment of the present invention used in a telecommunications (Telco) environment. It is understood that the detailed description is not limited to a telecommunications environment and functions equally well in any environment requiring the management and deployment of systems/services utilizing multiple components and/or elements and/or resources.

Data Structure and Processing

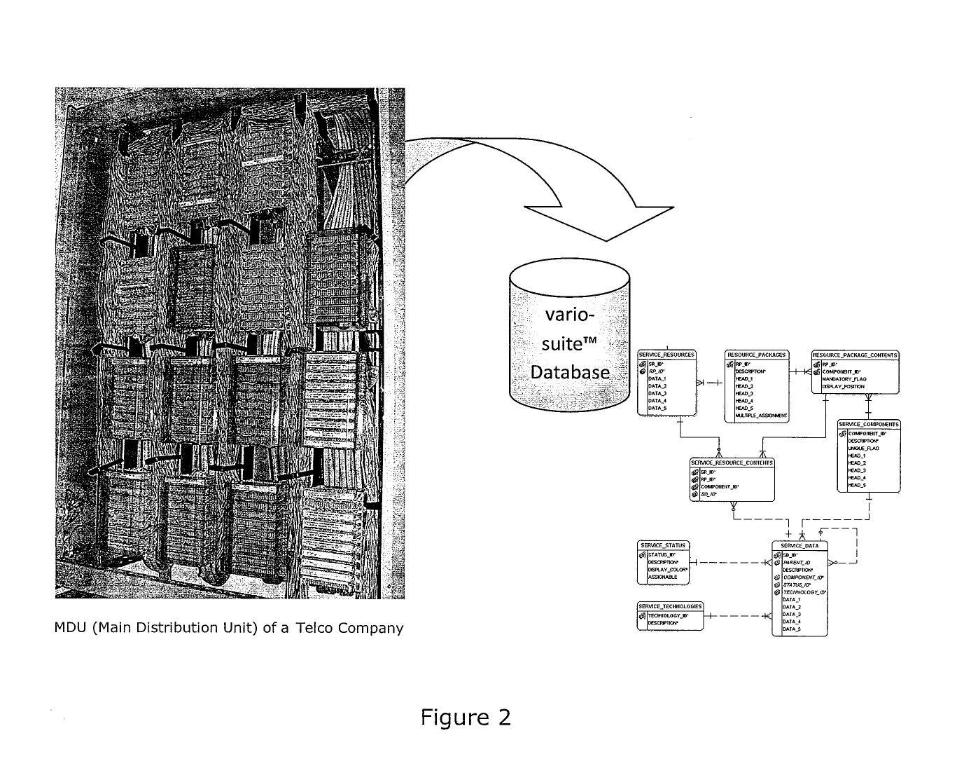

The Telco industry uses an MDU (Main Distribution Unit) structure such as the one shown in FIG. 2. The challenges addressed by the present invention include converting such a structure into a format that a database can organize and manipulate; allow flexibility to be able to build new components and deploy them in the structure without having to change the entire data model; and provide a way to show the relationships between network elements and the service being provides to the end-customer.

The data model should map data and processes that occur in actual implementation of the services. The data model and resource creation process of the present invention manages these specific requirements efficiently.

Data Model “Elements”

A novel aspect of the present invention is the use of parent-child-Ids in the data model and resource creation process. The Telco (in this example) decides what kind of elements are to be maintained. The method/system of the present invention generates a hierarchical structure with its different elements or “objects”. One element can become a child-object of another element by using the various Ids described in more detail below.

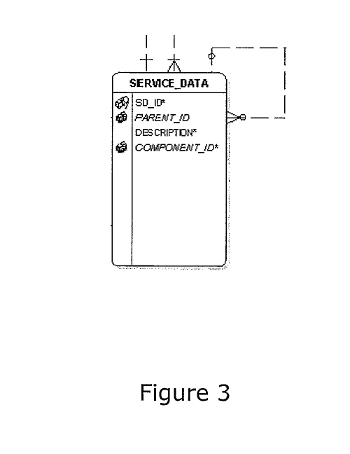

FIG. 3 illustrates an example of a table referred to in this example as a SERVICE_DATA table. This table contains a list of elements and the relationship between them, expressed by SD_ID and PARENT_ID. Additionally, a component type is also defined, described below.

This model allows that all the elements with their attributes are stored in only one database table. This makes it easy to handle allocational management of the many different elements, especially when it comes to changes or enhancements to the systems being deployed. Additionally, the software that builds the overall system based on the SERVICE_DATA table needs no modifications to accommodate the changes or enhancements. The information can be accessed by executing recursive queries on the same table.

Using different aliases for the same table name allows accessing the table recursively:

```
SELECT sd1.DESCRIPTION AS PIN
    , sd2.DESCRIPTION AS PANEL
    , sd3.DESCRIPTION AS RACK
FROM SERVICE_DATA sd1
  INNER JOIN SERVICE_DATA sd2 ON sd1.PARENT_ID =
  sd2.SD_ID
  INNER JOIN SERVICE_DATA sd3 ON sd2.PARENT_ID =
  sd3.SD_ID
WHERE sd1.COMPONENT_ID = 10020
```

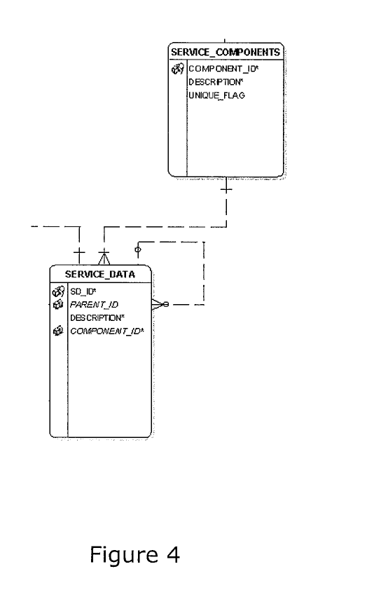

The attributes of the stored elements are defined in a table called SERVICE_COMPONENTS. The table contains all component types and is defined once. An example of the structure of the SERVICE_COMPONENTS table and its relationship to the SERVICE_DATA table is shown in FIG. 4. The SERVICE_COMPONENTS table contains the defined component types with their IDs, descriptions and property titles.

### EXAMPLE

Following is an example which will help to illustrate the contents of these tables and how they function. If a rack is being used with distribution panels in it and pins on the panels, a pin can be accessed by its SD_ID. Through the PARENT_ID information the panel to which the pin belongs can also be accessed, and using the PARENT_ID of the panel, the rack in which the panel is installed can be accessed/identified.

If there are components like above (pins, panels, racks) the table SERVICE_COMPONENTS may look as follows

| COMPONENT_ID | DESCRIPTION | UNIQUE_FLAG |
|---|---|---|
| 10010 | Rack | 0 |
| 10015 | Panel | 0 |
| 10020 | Pin | 1 |

The component types are only defined once.

The SERVICE_DATA table associated with this example may look as follows

| SD_ID | PARENT_ID | DESCRIPTION | COMPONENT_ID |
|---|---|---|---|
| 1 | <null> | Rack_1.1 | 10010 |
| 2 | 1 | Panel_1.1-1 | 10015 |
| 3 | 2 | Pin_1 | 10020 |
| 4 | <null> | Rack_1.2 | 10010 |
| 5 | 2 | Pin_2 | 10020 |
| 6 | 2 | Pin_3 | 10020 |
| 7 | 1 | Panel_1.2-1 | 10015 |
| 8 | 7 | Pin_2 | 10020 |

This above describes the following: there are 2 racks ‘Rack_{—}1.1’ and ‘Rack_{—}1.2’. Rack_{—}1.1 has ‘Panel_{—}1.1-1’ installed thereon. Rack_{—}1.2 has ‘Panel_{—}1.2-1’ installed thereon. Panel_{—}1.1-1 has pins ‘Pin_{—}1’, ‘Pin_{—}2’ and ‘Pin_{—}3’ installed thereon and Panel_{—}1.2-1 has ‘Pin_{—}2’ also installed thereon (could be the same position on the panel but it is on a different panel). When Pin_{—}3 with the SQL identifications above is accessed, it can easily be determined that Pin_{—}2 is located on Panel_{—}1.1-1 in Rack_{—}1.1.

The Customer Process

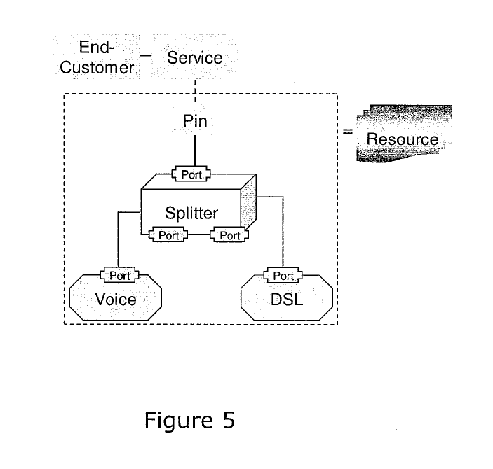

The above information relates to the Telco customer as follows: The customer orders services, e.g. a DSL and Voice-Service. The customer will need to have an access line for a subscriber terminal where the service will be delivered. The end of the line is connected to the Telco equipment and several components of the network. The combination of all these elements, which are part of this service, is referred to herein as a resource. This configuration is illustrated in FIG. 5.

A resource consists (in this example) of all elements (active or passive components) from the access line, to the Switch and DSL node, to the pin where the customer can be or is connected, and the relation between all these components.

Data Model “Resource”

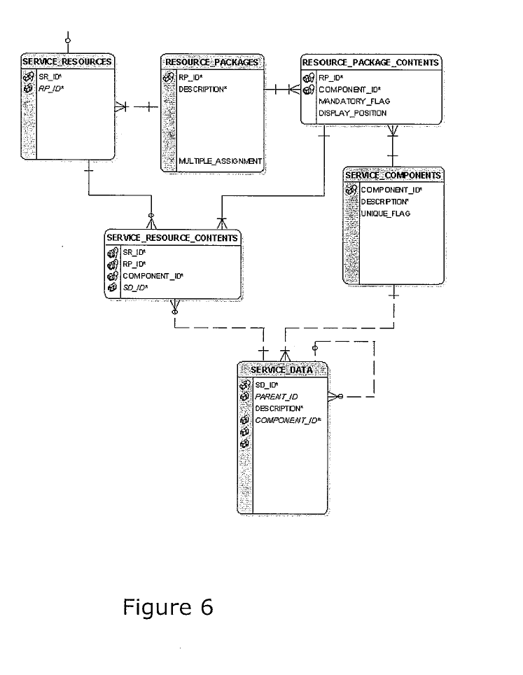

Various elements (created by the mechanisms in described above) can be combined together to form a resource. This resource is directly related to a service a Telco wants to offer. Because a Telco is offering multiple services, resources will have different characteristics. Each of these characteristics, which means a unique combination of elements, is called a resource package and is stored in a table referred to herein as RESOURCE_PACKAGES, shown in FIG. 6.

After setting up the recourse packages the database allows the selection of all the individual elements that it is desired to combine. Each generated combination produces an individual resource and is available in the system, stored in table SERVICE_RESOURCES. It will be ready to be added to a service of a customer when needed. It basically identifies the various elements needed to provide a particular service, in a single “package”.

VarioResource

The module for the management of network resources, referred to herein as “varioResource”, allows a transparent assignment of network elements to customers. Structured tree diagrams support the setup process. The module uses the Database model described above. Advantages of this system include: Complex network structures are transparent and available at the customer level; and all necessary functions are integrated in one module. The varioResource user can define the elements, hierarchical structures and links.

Following is a description of how to work with the present invention. The procedure is performed in 4 steps: creation of the component types; implementation of the hierarchical order; definition of resource types; and linking elements together to create resources using the resource type definitions.

Creation of Component Types

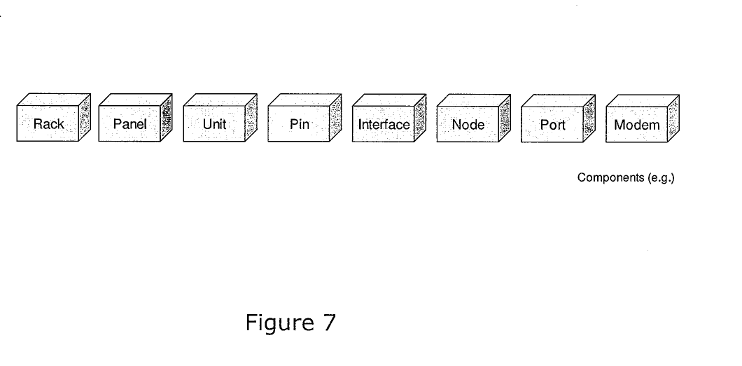

To create the component types, their property fields and status information fields are identified independently from any hierarchical structure. These component types can be active components (nodes, units, interfaces, ports etc.) or passive components (MDUs, racks, boards, panels, pins, etc.). It should also be determined whether an element based on this component type can appear only once or more than once. At that time these components have no relation to each other, they are simply identified. FIG. 7 shows a typical set of components that might be found in a Telco structure.

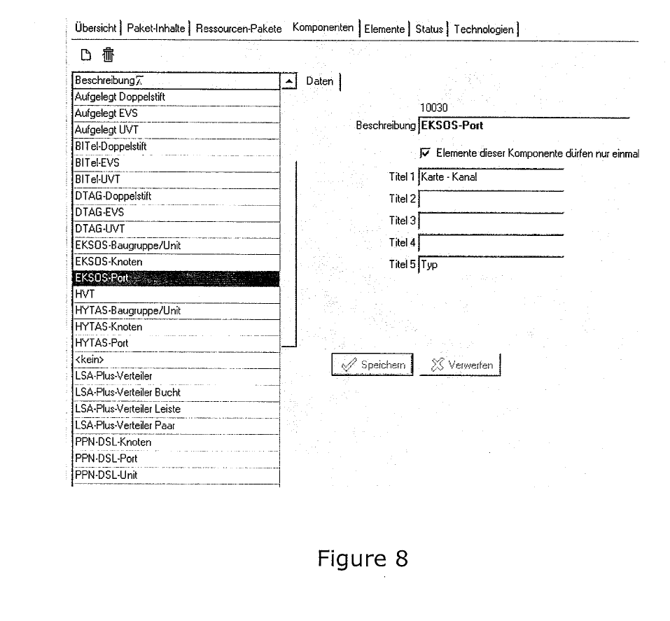

The screenshot of FIG. 8 displays the defined component types of an existing system. Highlighted is a port of an EKSOS node (for voice service) with the property titles.

Implementation of a Hierarchical Order

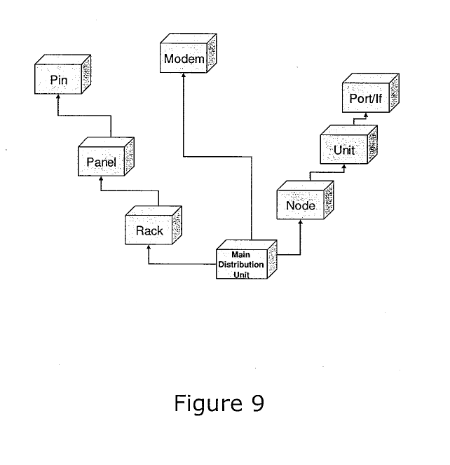

The next step is the creation of elements based on the identified component types, such as MDUs (main distribution unit), in a definable hierarchical order. This is done by establishing relationships between certain components that make up the element. For example, a panel with a certain number of pins is established as having a relationship with a rack. A distribution panel contains several pins but one particular pin can only exist once and on one panel. Hierarchical structures with different numbers of nodes can be created as needed. FIG. 9 illustrates an example of an element structure.

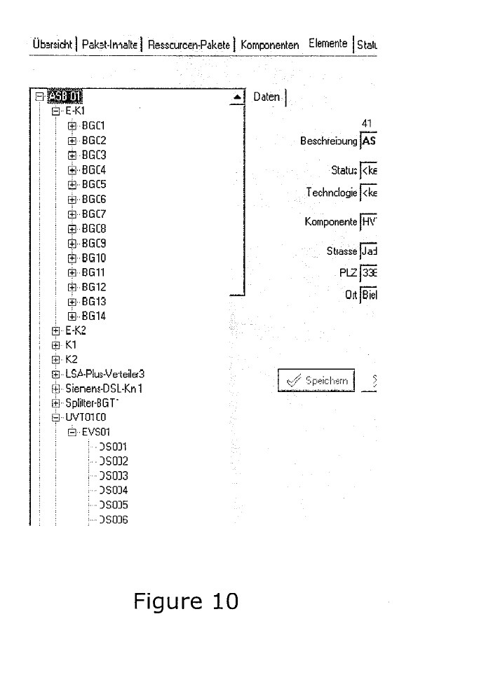

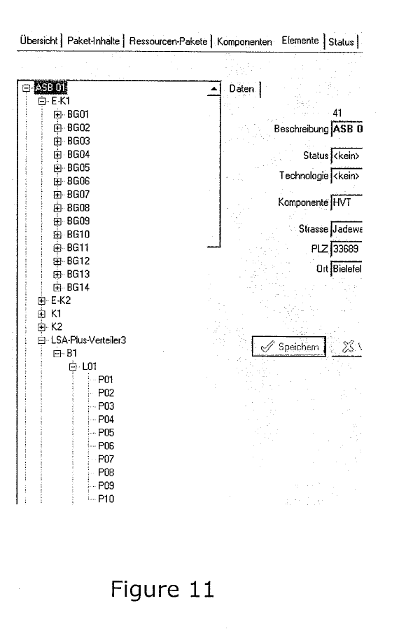

The screenshot of FIG. 10 shows the elements in a hierarchical order described below. The first node (ASB xx) is the MDU site with property fields. The second node shows nodes (EKSOS node (E-Kx), DSL node (Siemens-DSL-Kn.x), HYTAS node (Kx)); service interface points (SIP) (UVTxxxx), distributors (LSA-Plus-Verteilerx); splitters (Splitter-BGTx), etc. The third node displays the units (BGxx) or panels (EVSxx) in the above objects. The fourth node shows the interfaces of the active objects (Pxx) or the pins (DSxxx) of the passive objects. The number of nodes needed to display a network object is freely definable as can be seen in FIG. 11, with the distributor ‘LSA-Plus-Verteiler3’ having one more node.

### Definition of Resource Types and Resources

Defining resource types will now be described. Elements of the lowest node (pins, ports, interfaces) are linked to resources. Then, as many elements of the lowest node as are needed are connected to resources corresponding to one of the defined resource types. For example, if there is a resource type called ISDN-DSL, it might contain elements for the voice branch and the DSL branch, a splitter interface and a pin to which a customer can be connected.

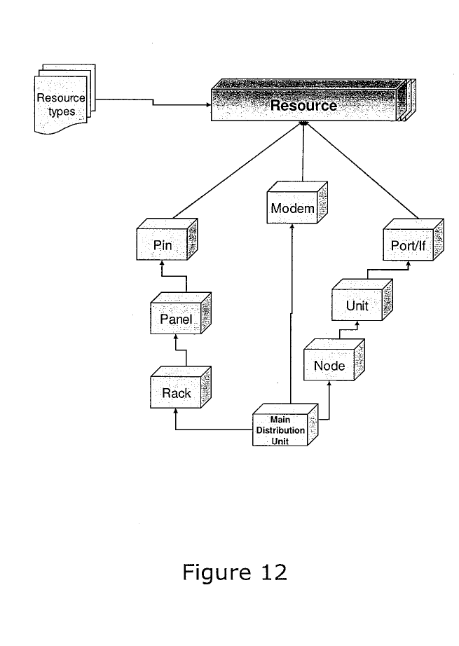

In varioResource, a resource for a customer connection can be a pin, when all the elements, such as ports on active elements and pins on distribution panels (and a splitter interface if DSL is wanted by the customer) are connected together so that a connected customer is able to work via that pin. FIG. 12 shows an example of a defined resource.

Such a created resource can be assigned to a service which is integrated in a customer's contract. Through this assignment it is possible to show at the contract level the network components that are in use by a customer.

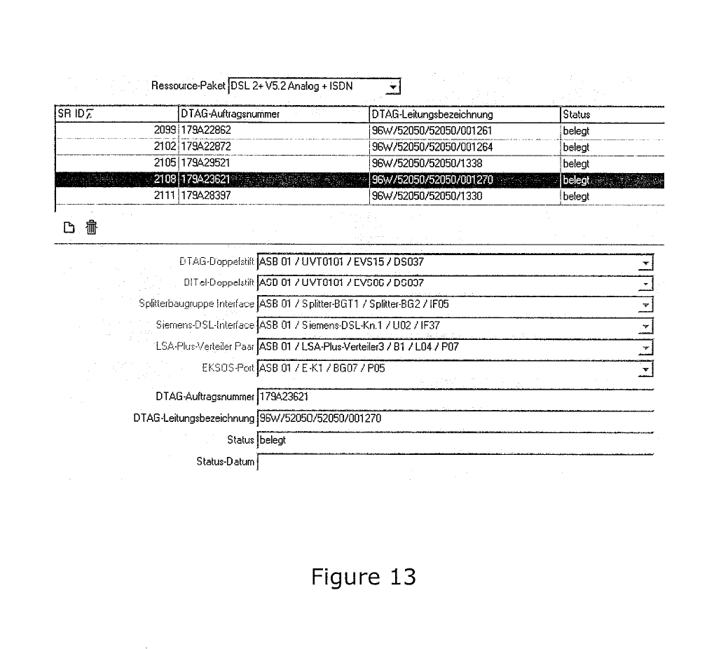

The screenshot of FIG. 13 illustrates displays the content of the highlighted resource of type ‘DSL2+ V5.2 Analog+ISDN’.

Lines 1, 2 and 5 contain pins, line 3 a splitter interface, line 4 a DSL interface and line 6 an EKSOS node interface. Lines 7 to 10 contain additional information of the resource. Active and passive elements may be shown in different colors if desired. Also shown is the information for each of the elements backwards to their root node.

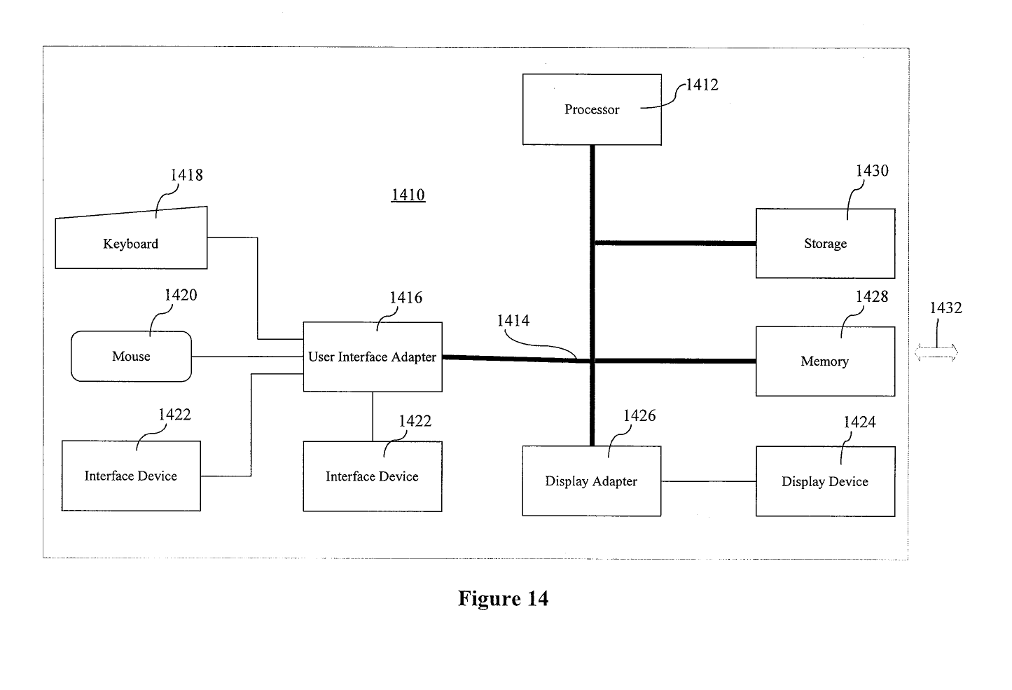

Following is a description of a typical processing environment which can be used to create and manage the hierarchical structures in accordance with the present invention. FIG. 14 illustrates a representative workstation hardware environment in which the present invention may be practiced. The environment of FIG. 14 comprises a representative single user computer workstation 1400, such as a personal computer, including related peripheral devices. The workstation 1400 includes a microprocessor 1412 and a bus 1414 employed to connect and enable communication between the microprocessor 1412 and the components of the workstation 1400 in accordance with known techniques. The workstation 1400 typically includes a user interface adapter 1416, which connects the microprocessor 1412 via the bus 1414 to one or more interface devices, such as keyboard 1418, mouse 1420, and/or other interface devices 1422, which can be any user interface device, such as a touch sensitive screen, digitized entry pad, etc. The bus 1414 also connects a display device 1424, such as an LCD screen or monitor, to the microprocessor 1412 via a display adapter 1426. The bus 1414 also connects the microprocessor 1412 to memory 1428 and long term storage 1430 which can include a hard drive, tape drive, etc.

The workstation 1400 communicates via a communications channel 1432 with other computers or networks of computers. The workstation 1400 may be associated with such other computers in a local area network (LAN) or a wide area network, or the workstation 1400 can be client in a client/server arrangement with another computer, etc. All of these configurations, as well as the appropriate communications hardware and software, are known in the art.

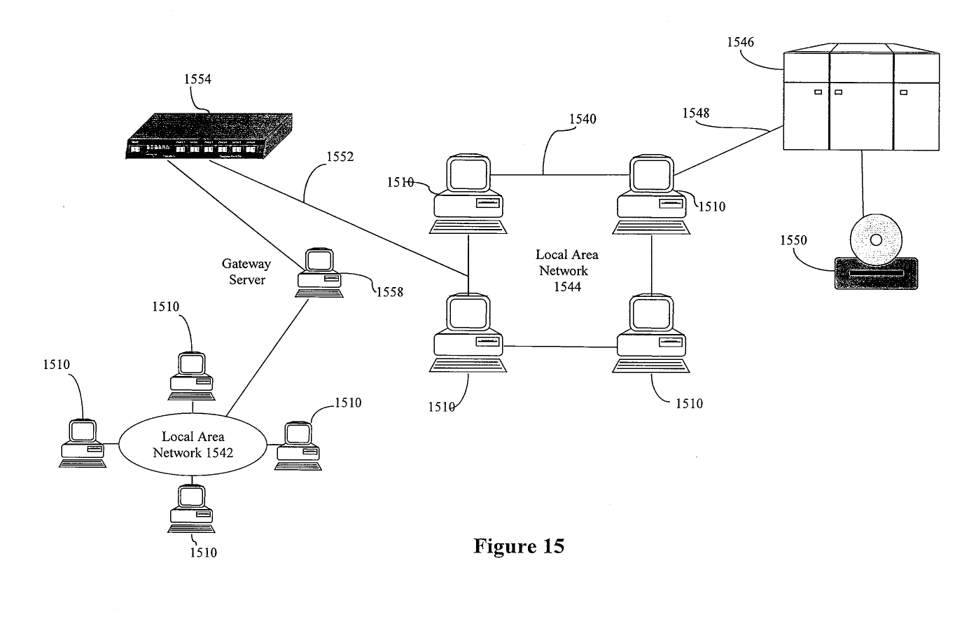

FIG. 15 illustrates a data processing network 1540 in which the present invention may be practiced. The data processing network 1540 includes a plurality of individual networks, including LANs 1542 and 1544, each of which includes a plurality of individual workstations 1400. Alternatively, as those skilled in the art will appreciate, a LAN may comprise a plurality of intelligent workstations coupled to a host processor.

Still referring to FIG. 15, the data processing network 1540 may also include multiple mainframe computers, such as a mainframe computer 1546, which may be preferably coupled to the LAN 1544 by means of a communications link 1548.

The mainframe computer 1546 may also be coupled to a storage device 1550, which may serve as remote storage for the LAN 1544. Similarly, the LAN 1544 may be coupled to a communications link 1552 through a router 1554 and a communications link 1556 to a gateway server 1558. The gateway server 1558 is preferably an individual computer or intelligent workstation which serves to link the LAN 1542 to the LAN 1544.

Those skilled in the art will appreciate that the mainframe computer 1546 may be located a great geographic distance from the LAN 1544, and similarly, the LAN 1544 may be located a substantial distance from the LAN 1542. For example, the LAN 1542 may be located in California, while the LAN 1544 may be located in Texas, and the mainframe computer 1546 may be located in New York.

Software programming code which embodies the present invention is typically stored in permanent storage of some type, such as the permanent storage 1430 of the workstation 1400. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A method of managing the deployment of components in a system, comprising:
identifying each component type used in said system using a unique component type identifier for each component type;
identifying each element used in said system using a unique element identifier; and
establishing a hierarchical relationship between elements to define resources to be made available for use in said system; and
storing data regarding the identified component types, identified elements, and hierarchical relationships in a database for use in managing the deployment of components in the system.

2. The method of claim 1, further comprising:
establishing a parent-child relationship between elements within a defined resource.

3. The method of claim 2, further comprising:
storing said stored data in a data table; and
recursively executing queries on said data table to build said system.

4. A system of managing the deployment of components in a system, comprising:
means for identifying each component type used in said system using a unique component type identifier for each component type;
means for identifying each element used in said system using a unique element identifier;
means for establishing a hierarchical relationship between elements to define resources to be made available for use in said system; and
means for storing data regarding the identified component types, identified elements, and hierarchical relationships in a database for use in managing the deployment of components in the system.

5. The system of claim 4, further comprising:
means for establishing a parent-child relationship between elements within a defined resource.

6. The system of claim 5, further comprising:
means for storing said stored data in a data table; and
means for recursively executing queries on said data table to build said system.

7. A computer program product for managing the deployment of components in a system, the computer program product comprising a computer-readable storage medium having computer-readable program code embodied in the medium, the computer-readable program code comprising:
computer-readable program code that identifies each component type used in said system using a unique component type identifier for each component type;
computer-readable program code that identifies each element used in said system using a unique element identifier;
computer-readable program code that establishes a hierarchical relationship between elements to define resources to be made available for use in said system; and
computer-readable program code that stores data regarding the identified component types, identified elements, and hierarchical relationships in a database for use in managing the deployment of components in the system.

8. The computer program product of claim 7, further comprising:
computer-readable program code that establishes a parent-child relationship between elements within a defined resource.

9. The computer program product of claim 8, further comprising:
computer-readable program code that stores said stored data in a data table; and
computer-readable program code that recursively executes queries on said data table to build said system.
